(19) United States
(12) Patent Application Publication
(10) Pub. No.: US 2015/0028874 A1
(43) Pub. Date: Jan. 29, 2015

(54) Apparatus and Method for At-Bit Resistivity Measurements By A Toroidal Transmitter

(71) Applicants: Naizhen Liu, Beijing (CN); Qihui Zhao, Beijing (CN); Yuzhou Lu, Beijing (CN); Yonghe Li, Panjin (CN); Rui Bai, Panjin (CN); Jing Li, Houston, TX (US); Ce Liu, Houston, TX (US)

(72) Inventors: Naizhen Liu, Beijing (CN); Qihui Zhao, Beijing (CN); Yuzhou Lu, Beijing (CN); Yonghe Li, Panjin (CN); Rui Bai, Panjin (CN); Jing Li, Houston, TX (US); Ce Liu, Houston, TX (US)

(21) Appl. No.: 13/949,140

(22) Filed: Jul. 23, 2013

(51) Int. Cl. E21B 49/00; G01V 3/20; G01V 3/34

(52) U.S. Cl. CPC E21B 49/00; G01V 3/34; G01V 3/20
USPC 324/338

(57) ABSTRACT

An apparatus for making formation resistivity measurements near a drill bit includes a tool body, a toroidal antenna deployed on the tool body near the drill bit, a coupler coupled to the toroidal antenna, a transmitter circuit coupled with the toroidal antenna via the coupler to provide voltage signals to energize the toroidal antenna, a receiver circuit coupled with the toroidal antenna via the coupler to couple electrical current signals flowing in the toroidal antenna to the receiver circuit, and a controller and processor module coupled to the transmitter circuit and the receiver circuit to control the measurement operation and calculate formation resistivity. Formation resistivity is computed based on the voltage signals to energize the toroidal antenna and the measured electrical current signals flowing in the toroidal antenna. A corresponding method for making formation resistivity measurements near a drill bit is also provided.

### FIELD

The present invention relates generally to the field of electrical resistivity well logging. More particularly, the invention relates to an apparatus and a method for making at-bit resistivity measurements of a subterranean formation adjacent a wellbore.

### BACKGROUND

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation. It is preferable to keep the borehole in the pay zone (the formation with hydrocarbons) as much as possible so as to maximize the recovery.

FIG. 1 illustrates a front view of a bottom hole drilling assembly (“BHA”) 101 assembled with a conventional logging while drilling system 100. The conventional logging while drilling system 100 in the FIG. 1 can include a drilling rig 102, a drill string 106, and the BHA 101, which can include a drilling bit 110, a mud motor 114, a near bit sensor unit 116, and a LWD system 112. The drill string 106 supported by the drilling rig 102 can extend from above a surface 104 down into a borehole 108. The drill string 106 can carry on the drilling bit 110 and the LWD system 112 to make measurements of subterranean formation properties while drilling.

The LWD system 112 can include various types of logging tools, such as a resistivity tool, an acoustic tool, a neutron tool, a density tool, a telemetry system. The telemetry system, i.e. a mud pulse telemetry system, can establish a communication link from the LWD system 112 to the surface (not shown in FIG. 1), being a relay for the at-bit information or other measured data to be sent to the surface.

FIG. 2A illustrates a prior art of a resistivity tool 200 deployed with multiple toroid transmitters and receivers. The resistivity tool 200 can include multiple toroid transmitters T1, T2, and T3 and a pair of toroid receivers R1 and R2 coaxially mounted on the collar 204 and positioned above the mud motor 114 for surrounding formation resistivity measurements. Each toroid transmitter T1, T2, or T3 has a different offset from the midpoint of the pair of toroid receivers R1 and R2 to obtain multiple depths of investigation.

For example, when the toroid transmitter T3 energizes, it can induce an axial current I₀ propagating down along the collar 204 and returning to the upper part of the collar 204 through surrounding formation as a returning current 202. The axial current I₀ propagating along the collar 204 can be measured at the toroid receivers R1 and R2 respectively, denoted as I₁ and I₂. The formation resistivity around the resistivity tool 200 can be computed according to the measured I₁ and I₂ at the toroid receivers R1 and R2 by Ohm's law as following Equation (1).

$$R = k \frac{{V}_{m}}{I} \qquad ( 1 )$$

Where R is the resistivity of surrounding formation; I is the measured current by the receiver; k is the tool's geometrical factor dependent on the spacing of toroids and tool dimensions; Vₘ is the applied excitation voltage to the transmitter.

The ratios of the axial currents measured at the first toroid receiver R1 and the second toroid receiver R2 can be calculated according to the equation (2) shown below and indicate the relative current flowing into the surrounding formation between the first and the second toroid receivers R1 and R2.

$$\{ \begin{matrix}{I}_{ratio} = \frac{{I}_{2}}{{I}_{1}} \\ {I}_{relative \text{-} ratio} = \frac{{I}_{2} - {I}_{1}}{{I}_{1}}\end{matrix} \qquad ( 2 )$$

where I₁ is the current measured at the first toroid receiver R1; I₂ is the current measured at the second toroid receiver R2.

The modeled results demonstrate that the Iᵣₐₜᵢₒ or Iᵣₑₗₐₜᵢᵥₑ₋ᵣₐₜᵢₒ defined in Equation (2) is a decreasing functions of the surrounding formation resistivity between the toroid transmitter T3 and the first and second toroid receivers R1 and R2. Accordingly, the formation resistivity can be determined by a multi-dimensional look-up table that is pre-calculated using electromagnetic forward modeling software. The multi-dimensional look-up table involves at least the formation resistivity, signal frequency, transmitter-receiver distance, and measured current ratios Iᵣₐₜᵢₒ and Iᵣₑₗₐₜᵢᵥₑ₋ᵣₐₜᵢₒ at the toroid receivers R1 and R2. Also, when the transmitters T1 or T2 energizes, additional resistivity measurement at different depths can be obtained.

FIG. 2B illustrates another prior art of a resistivity tool 206 deployed with multiple toroid transmitters and electrode receivers. The resistivity tool 206 can include two toroid transmitters T1 and T2 and three electrode receivers BR1, BR2, and BR3 coaxially mounted on the collar 204 and positioned above the mud motor 114 for surrounding formation resistivity measurements. When the transmitter T1 energizes, it can induce an axial current I₀ propagating up along the collar 204 and returning to the lower part of the collar 204 and the electrode receivers BR1, BR2, and BR3 as I₁, I₂, and I₃, through surrounding formation. The currents I₁, I₂, and I₃ can be measured by the electrode receivers BR1, BR2, and BR3 respectively. The formation resistivity then can be determined by the Equation (3) below.

$$\{ \begin{matrix}{R}_{1} = \frac{V}{{K}_{1} {I}_{1}} \\ {R}_{2} = \frac{V}{{K}_{2} {I}_{2}} \\ {R}_{3} = \frac{V}{{K}_{3} {I}_{3}}\end{matrix} \qquad ( 3 )$$

where V is the excitation voltage applied to the toroid transmitter T1; I₁ is the current measured at the first receiver BR1; I₂ is the current measured at the receiver BR2, I₃ is the current measured at the receiver BR3. The coefficients K₁, K₁, and K₃ are geometry factors of the tool for electrode receivers BR1, BR2, and BR3 respectively, and they can be determined by forward modeling software or calibration procedure. The three measured resistivities R1, R2, and R3 correspond to the resistivity of the shallow, middle, and deep depths of formation respectively.

The at-bit information can include information in regards to environmental conditions of a surrounding subterranean near the drill bit, which becomes important operational and directional parameters for the driller to adjust its direction in wellbore drilling on a real time basis. However, due to the mechanical complexity and limited space near the drill bit, the LWD system can not be disposed near the drill bit directly but has to be placed above the mud motor and away from the drill bit at least 30 feet. As a result, the resistivity tool may have a lag on measurements of environmental conditions around the drilling bit (the distance between the drilling bit and the resistivity tool could be 30 feet or more).

As described above, a need exists for an improved apparatus and method for measurements of environmental conditions of formation around a drill bit.

A further need exists for an improved apparatus and method for measurements of formation resistivity utilizing a resistivity tool which combines the transmitter with the receiver.

The present embodiments of the present invention meet these needs and improve on the technology.

### SUMMARY OF THE INVENTION

This section provides a general summary of the disclosure, and is not a comprehensive disclosure of its full scope or its entire feature.

In one preferred embodiment, an apparatus for making formation resistivity measurements near a drill bit includes a tool body, a toroidal antenna deployed on the tool body near the drill bit, a transmitter circuit configured to provide voltage signals to energize the toroidal antenna, a receiver circuit configured to measure electrical current signals flowing in the toroidal antenna, and a coupler coupled the transmitter toroidal antenna to relay signals between the transmitter circuit and the receiver circuit and the toroidal antenna.

In some embodiments, formation resistivity is computed based on the voltage signals and the measured electrical current signals.

In some embodiments, the voltage signals are oscillating signals.

In some embodiments, the voltage signals are constant signals.

In some embodiments, the apparatus further includes a controller and processor module coupled to the receiver circuit and the transmitter circuit to control the measurement operation and calculate formation resistivity.

In some embodiments, the apparatus further includes a storage device coupled to the controller and processor module to store with a conversion chart for converting the voltage signals and the measured electrical current signals into formation resistivity.

In some embodiments, the coupler couples the electrical current signals from the toroidal antenna to the receiver circuit.

In other embodiments, the toroidal antenna is a coil winding on a toroid body made of magnetic materials.

In other embodiments, the tool body is flowed with an induced axial current.

In other embodiments, the axial current is proportional to the electrical current signals.

In another preferred embodiment, an apparatus for making formation resistivity measurements near a drill bit includes a tool body, a toroidal antenna deployed on the tool body near the drill bit, a coupler coupled to the toroidal antenna, a transmitter circuit coupled with the toroidal antenna to provide voltage signals to energize the toroidal antenna, a receiver circuit coupled with the toroidal antenna via the coupler to couple electrical current signals flowing in the toroidal antenna to the receiver circuit, and a controller and processor module coupled to the transmitter circuit and the receiver circuit to control the measurement operation and calculate formation resistivity.

In some embodiments, formation resistivity is computed based on the voltage signals to energize the toroidal antenna and the measured electrical current signals flowing in the toroidal antenna.

In some embodiments, the apparatus further includes a storage device coupled to the controller and processor module to store with a conversion chart for facilitating conversion from the voltage signals and the measured electrical current signals into formation resistivity.

In some embodiments, the tool body is flowed with an induced axial current.

In other embodiments, the induced axial current is a decreasing function of formation resistivity.

In still another embodiments, a method for making formation resistivity measurements near a drill bit includes deploying a tool body mounted with a toroidal antenna in a borehole, utilizing a transmitter to apply voltage signals to the toroidal antenna, utilizing a receiver to measure induced electrical current signals on the toroidal antenna, and computing corresponding formation resistivity based on the applied voltage signals and induced electrical current signals on the toroidal antenna.

In some embodiments, the method further includes providing a coupler to couple the electrical current signals from the toroid antenna to the receiver.

In some embodiments, the method further includes providing a pre-built conversion chart to facilitate the conversion from the applied voltage signals and the induced electrical current signals in the toroidal antenna.

In other embodiments, the method further includes utilizing a controller and processor module to control the measurement operation and calculate formation resistivity.

In still other embodiments, the controller and processor module includes a storage device.

In sill other embodiments, the electrical current signal is a decreasing function of formation resistivity.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 illustrates a front view of a bottom hole drilling assembly (“BHA”) assembled with a conventional logging while drilling system.

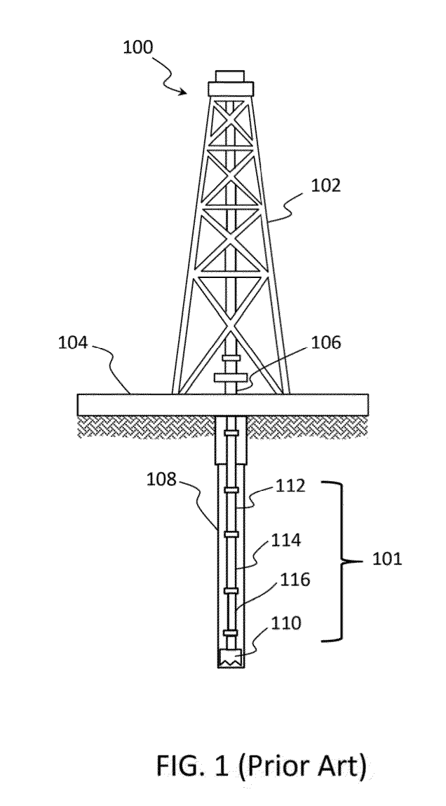

FIG. 2A illustrates a prior art of a resistivity tool deployed with multiple toroid transmitters and receivers.

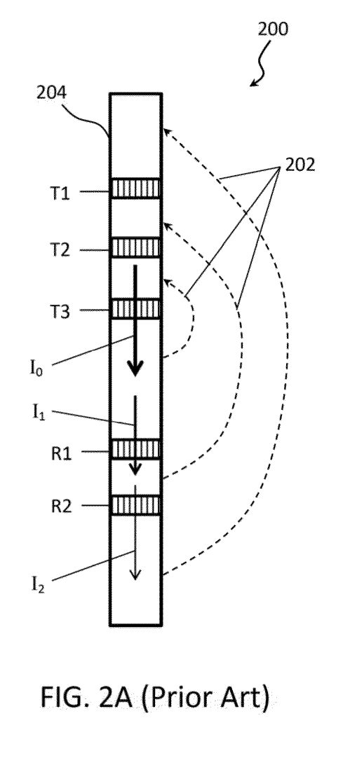

FIG. 2B illustrates another prior art of a resistivity tool deployed with multiple toroid transmitters and electrode receivers.

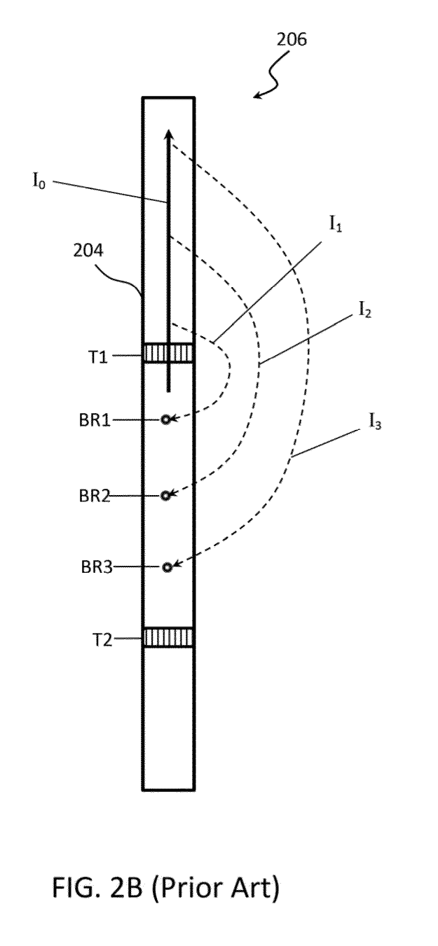

FIG. 3 illustrates a schematic presentation, partially in block diagram form, of a tool including a toroidal antenna, a coupler, a receiver circuit, a transmitter circuit, a controller and processor module, and a storage device.

FIG. 4A illustrates exemplary current directions flowing in the tool body 300 and surrounding formation.

FIG. 4B illustrates an enlarged view of the toroidal antenna shown in the FIGS. 3 and 4A.

FIG. 4C illustrates modeling results in term of a data graph of second axial current on the tool body versus formation resistivity.

FIG. 5 illustrates modeling results in term of a data graph of second axial current on the tool body versus first toroid current.

FIG. 6 illustrates modeling results in term of a data graph of first toroid current versus formation resistivity.

FIG. 7A illustrates a simulation model.

FIG. 7B shows measurement results of the simulation model provided in the FIG. 7A in term of a data graph of a transmitter position along z-axis versus measured resistivity.

FIG. 8 illustrates a flow chart of a method for formation resistivity measurements near a drill bit.

The present embodiments are detailed below with reference to the listed Figures.

### DETAILED DESCRIPTION OF THE EMBODIMENTS

Before explaining the present apparatus in detail, it is to be understood that the present invention is not limited to the particular embodiments and that it can be practiced or carried out in various ways.

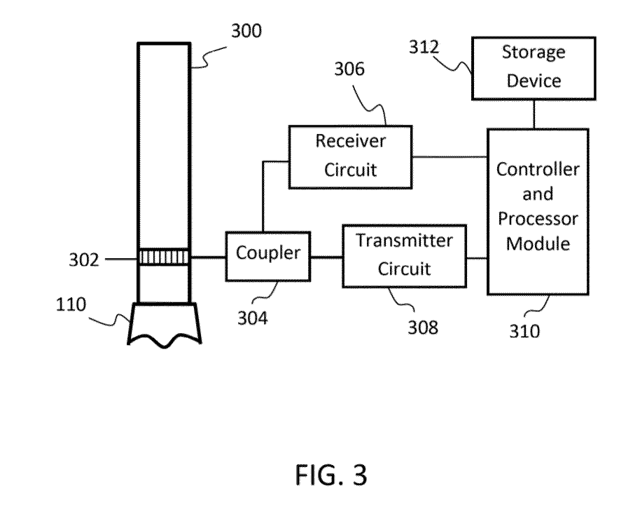

FIG. 3 illustrates a schematic presentation, partially in block diagram form, of a tool including a toroidal antenna 302, a coupler 304, a receiver circuit 306, a transmitter circuit 308, a controller and processor module 310, and a storage device 312. A tool body 300 can include at least one toroidal antenna 302 deployed near the drill bit 110. The receiver circuit 306 and the transmitter circuit 308 can be coupled with the toroidal antenna 302 through the coupler 304. The transmitter circuit 308 can be configured to provide voltage signals to energize the toroidal antenna 302. The receiver circuit 306 can be configured to measure the electrical current signals flowing in the toroidal antenna 302. The coupler 304 can be configured to couple the electrical current signals from the toroidal antenna 302 to the receiver circuit 306.

In some embodiments, the receiver circuit 306 and the transmitter circuit 308 can be coupled to a controller and processor module 310 which can be configured to control the operation and calculate formation resistivity based on applied voltage signals on the transmitter circuit 308 to energize the toroidal antenna 302 and the measured electrical current signals flowing in the toroidal antenna 302.

In some embodiments, the transmitter circuit 308 can be applied with constant voltage signals or oscillating voltage signals.

In some embodiments, the toroidal antenna 302 can include a coil.

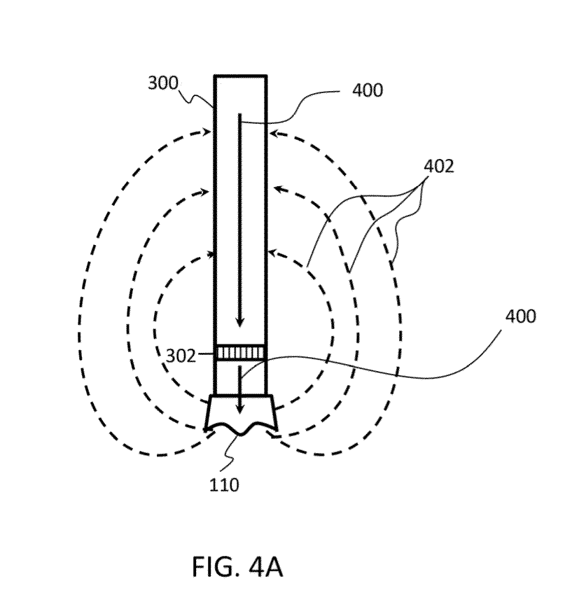

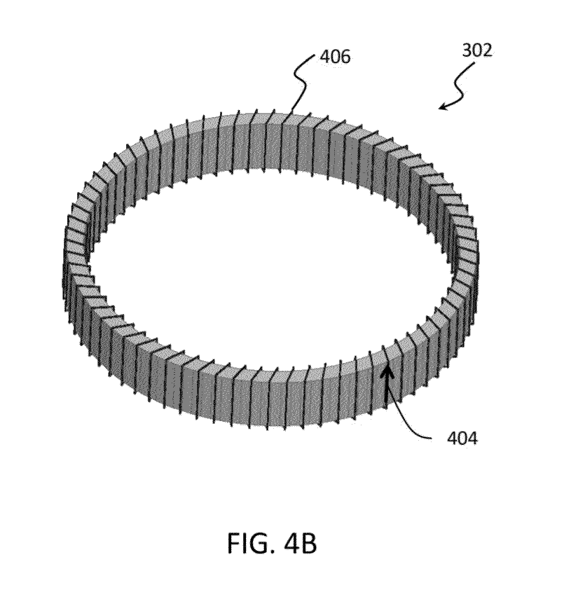

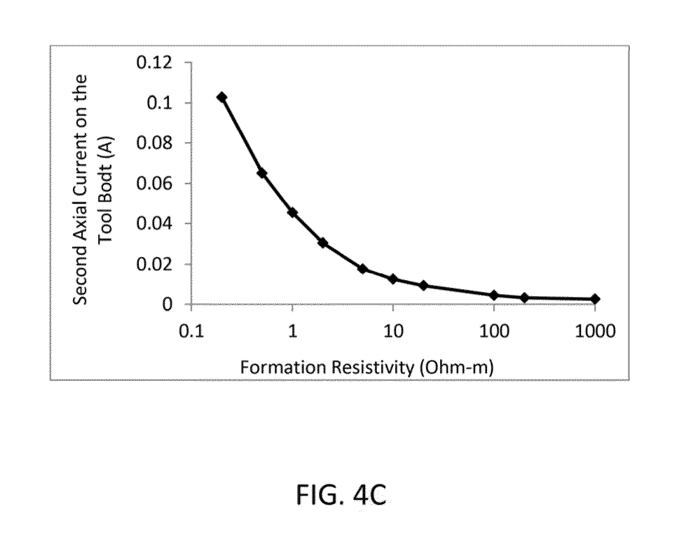

FIG. 4A illustrates exemplary current directions flowing in the tool body 300 and surrounding formation according to some embodiments of the present invention. In operation, when the toroidal antenna 302 is energized by a voltage-type transmitter circuit, which can provide voltage signals with variable currents, a first toroid current (not shown in the FIG. 4A) can be induced in the coils of the toroidal antenna 302 and a second axial current 400 can be generated simultaneously along the tool body 300. The second axial current 400 can propagate down along the tool body 300 and return to the upper part of the tool body 300 as returning currents 402 to form a closed loop.

In some embodiments, the current directions shown in the FIG. 4A can be reversed.

FIG. 4B illustrates an enlarged view of the toroidal antenna 302 shown in the FIGS. 3 and 4A according to some embodiments of the present invention. The first toroid current 404 can be induced in the coils 406 of the toroidal antenna 302.

FIG. 4C illustrates modeling results in term of a data graph of second axial current on the tool body versus formation resistivity according to some embodiments of the present invention. It can be observed that the second axial current 400 is a decreasing function of the surrounding formation resistivity when the toroidal antenna 302 is energized by a constant voltage signal. A large second axial current 400 indicates low surrounding formation resistivity. The larger second axial current 400 is, the larger returning current 402 would be generated and passing through surrounding formation and back to the toroidal antenna 302.

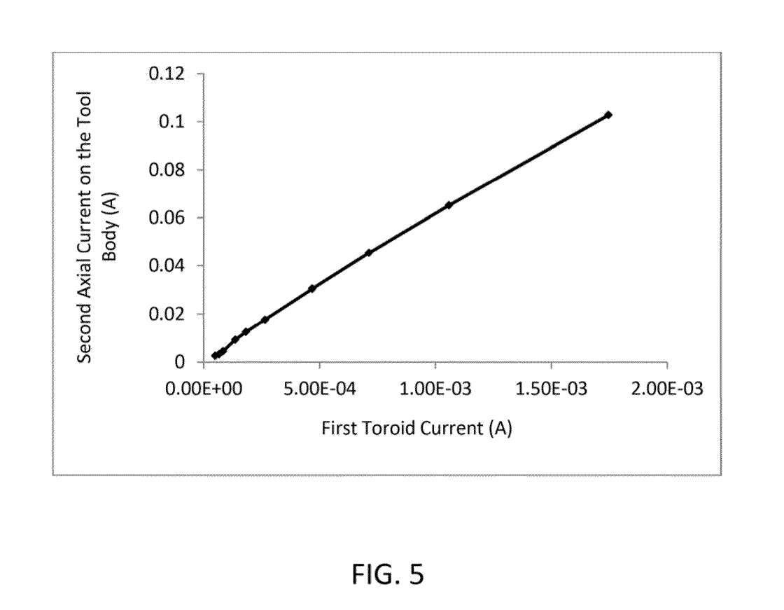

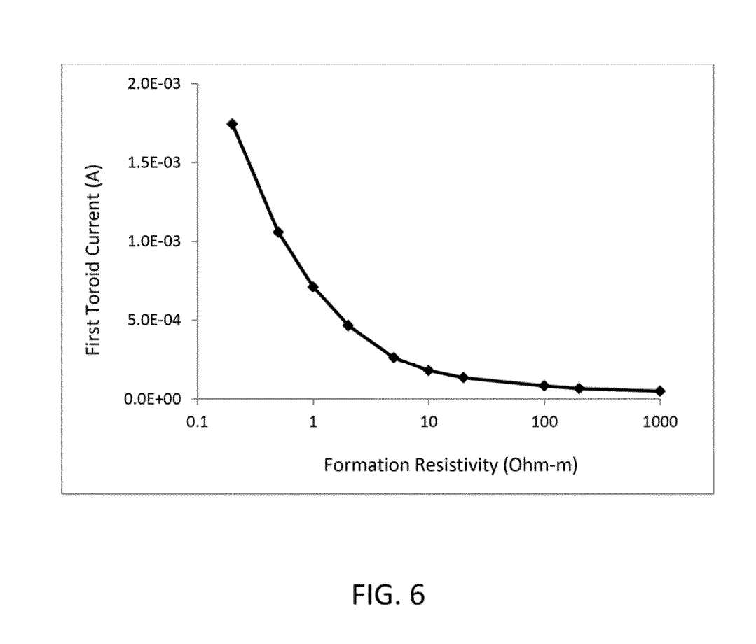

FIG. 5 illustrates modeling results in term of a data graph of second axial current on the tool body versus first toroid current according to some embodiments of the present invention. It can be observed that the first toroid current 404 is proportional to the second axial current 400. Therefore, the first toroid current 404 would be also a decreasing function of the surrounding formation resistivity, as shown in the modeling results in term of a data graph of first toroid current versus formation resistivity shown in the FIG. 6.

In some embodiments, a conversion chart showing the correlation between the first toroid current 404 and the surrounding formation resistivity or the correlation between the second axial current 400 and the surrounding formation resistivity can be pre-calculated and built using software, e.g., HFSS or COMSOL, according to the surrounding geometric structures and formation parameters. In that way, the conversion from the measured first toroid current 404 or the second axial current 400 and applied voltage signals on the transmitter circuit 308 into corresponding formation resistivity can be facilitated.

In some embodiments, the conversion chart can be stored in the storage device 312 shown in the FIG. 3.

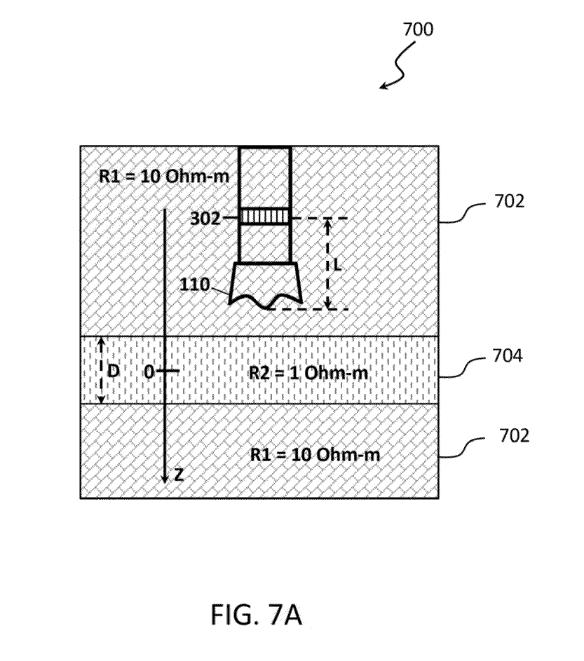

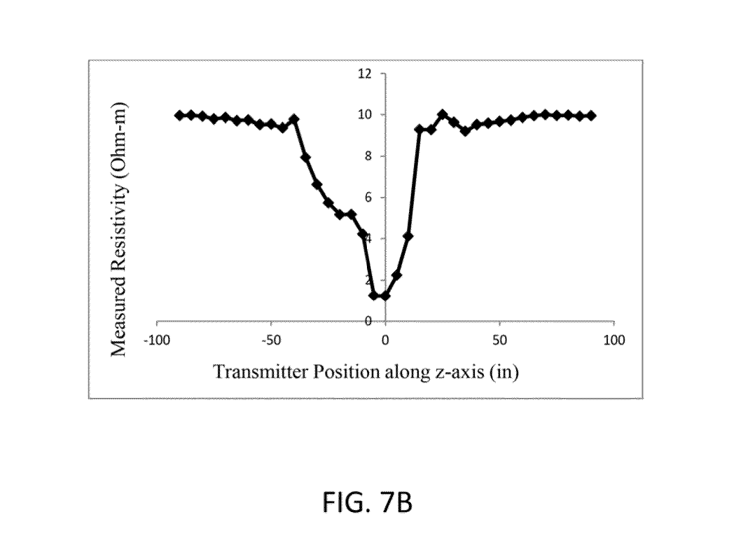

FIG. 7A illustrates a simulation model 700 according to some embodiments of the present invention, and FIG. 7B shows modeled results of the simulation model 700 provided in the FIG. 7A in term of a data graph of measured resistivity versus a transmitter position along z-axis. In FIG. 7A, the model 700 can contain a formation 702 and a formation bed 704. The formation 702 can have a resistivity of 10 ohm*m and the formation bed 704 can have a resistivity of 1 ohm*m. The tool body 300 depicted in FIG. 3 can be initially placed in formation 702 and approaches to the formation bed 704 for simulation.

In some embodiments, the formation bed704 can be a shoulder bed.

The present invention is in no way limited to any particular number, type, or location of the toroidal antenna, transmitter circuit, and receiver circuit.

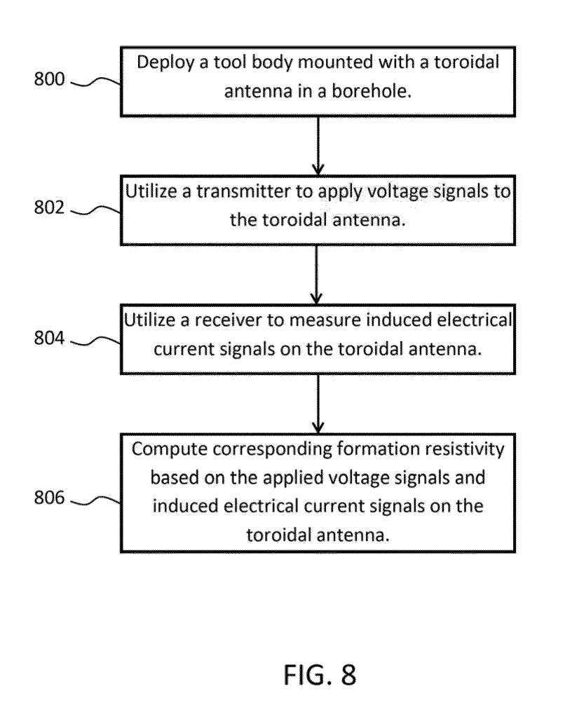

FIG. 8 illustrates a flow chart of a method for formation resistivity measurements near a drill bit according to some embodiments of the present invention. A method for making formation resistivity measurements near a drill bit can comprise deploying a tool body mounted with a toroidal antenna in a borehole 800, utilizing a transmitter to apply voltage signals to the toroidal antenna 802, utilizing a receiver to measure induced electrical current signals on the toroidal antenna 804, and computing corresponding formation resistivity based on the applied voltage signals and induced electrical current signals on the toroidal antenna 806.

In some embodiments, the method for formation resistivity measurements near a drill bit can further comprise providing a coupler to couple the electrical current signals from the toroid antenna to the receiver.

In some embodiments, the method for formation resistivity measurements near a drill bit can further comprise providing a pre-built conversion chart to facilitate the conversion from the applied voltage signals and the induced electrical current signals into corresponding formation resistivity.

In some embodiments, the method for formation resistivity measurements near a drill bit can further comprise utilizing a controller and processor module to control the measurement operation and calculate formation resistivity.

In some embodiments, the controller and processor module can include a storage device.

The present invention is in no way limited to any particular order of steps or requires any particular step illustrated in FIG. 8.

The present invention has been described in terms of specific embodiments incorporating details to facilitate the understanding of principles of construction and operation of the invention. It will be readily apparent to one skilled in the art that other various modifications may be made in the embodiment chosen for illustration without departing from the spirit and scope of the invention as defined by the claims.

What is claimed is:

1. An apparatus for making formation resistivity measurements near a drill bit comprising:
a tool body;
a toroidal antenna deployed on the tool body near the drill bit;
a transmitter circuit configured to provide voltage signals to energize the toroidal antenna;
a receiver circuit configured to measure electrical current signals flowing in the toroidal antenna;
a coupler coupled the transmitter circuit and the receiver circuit to the toroidal antenna to relay signals between the transmitter circuit and the receiver circuit and the toroidal antenna; and wherein formation resistivity is computed based on the voltage signals and the measured electrical current signals.

2. The apparatus according to claim 1 wherein the voltage signals are oscillating signals.

3. The apparatus according to claim 1 wherein the voltage signals are constant signals.

4. The apparatus according to claim 1 further comprising a controller and processor module coupled to the receiver circuit and the transmitter circuit to control the measurement operation and calculate formation resistivity.

5. The apparatus according to claim 4 further comprising a storage device coupled to the controller and processor module to store with a conversion chart for converting the voltage signals and the measured electrical current signals into formation resistivity.

6. The apparatus according to claim 1 wherein the coupler couples the electrical current signals from the toroidal antenna to the receiver circuit.

7. The apparatus according to claim 1 wherein the toroidal antenna is a coil with electrical current signals flowing through.

8. The apparatus according to claim 1 wherein the tool body is flowed with an induced axial current.

9. The apparatus according to claim 8 wherein the axial current is proportional to the electrical current signals.

10. An apparatus for making formation resistivity measurements near a drill bit comprising:
a tool body;
a toroidal antenna deployed on the tool body near the drill bit;
a coupler coupled to the toroidal antenna;
a transmitter circuit coupled with the toroidal antenna via the coupler to provide voltage signals to energize the toroidal antenna;
a receiver circuit coupled with the toroidal antenna via the coupler to couple electrical current signals flowing in the toroidal antenna to the receiver circuit;
a controller and processor module coupled to the transmitter circuit and the receiver circuit to control the measurement operation and calculate formation resistivity; and
wherein formation resistivity is computed based on the voltage signals to energize the toroidal antenna and the measured electrical current signals flowing in the toroidal antenna.

11. The apparatus according to claim 10 further comprising a storage device coupled to the controller and processor module to store with a conversion chart for facilitating conversion from the voltage signals and the measured electrical current signals into formation resistivity.

12. The apparatus according to claim 10 wherein the toroidal antenna is a coil with electrical current signals flowing through.

13. The apparatus according to claim 10 wherein the tool body is flowed with an induced axial current.

14. The apparatus according to claim 13 wherein the induced axial current is a decreasing function of formation resistivity.

15. A method for making formation resistivity measurements near a drill bit comprising:
deploying a tool body mounted with a toroidal antenna in a borehole;
utilizing a transmitter to apply voltage signals to the toroidal antenna;
utilizing a receiver to measure induced electrical current signals on the toroidal antenna; and
computing corresponding formation resistivity based on the applied voltage signals and induced electrical current signals on the toroidal antenna.

16. The method according to the claim 15 further comprising providing a coupler to couple the electrical current signals from the toroid antenna to the receiver.

17. The method according to the claim 15 further comprising providing a pre-built conversion chart to facilitate the conversion from the applied voltage signals and the induced electrical current signals into corresponding formation resistivity.

18. The method according to claim 15 further comprising utilizing a controller and processor module to control the measurement operation and calculate formation resistivity.

19. The method according to claim 18 wherein the controller and processor module includes a storage device.

20. The method according to claim 15 wherein the electrical current signal is a decreasing function of formation resistivity.
